(19) United States
(12) Patent Application Publication
(10) Pub. No.: US 2011/0314975 A1
(43) Pub. Date: Dec. 29, 2011

(54) Rotating Device and Driver

(76) Inventor: Peter Anthony Steinert, Shropshire (GB)

(21) Appl. No.: 13/254,766

(22) PCT Filed: Mar. 5, 2010
(86) PCT No.: PCT/GB2010/000397

§ 371 Date: Sep. 2, 2011

(30) Foreign Application Priority Data
Mar. 5, 2009 (GB) 0903785.4

(51) Int. Cl. F16B 23/00; B25B 23/00

(52) U.S. Cl. 81/442; 411/403

(57) ABSTRACT

A rotating device (1) arranged to rotate about an axis and having a body portion (2) containing a cavity (20), the body portion (2) having an upper surface (10) having a substantially circular access hole (12) therethrough generally of a first radius from the axis and providing access to the cavity (20), and at least one drive surface arranged to have force applied thereto to rotate the device (1) and being provided in the cavity (20) at least a second radius from the axis wherein the second radius is greater than the first.

This invention relates to rotating devices and drivers arranged to engage and rotate the rotating devices. In particular, the invention relates to rotating devices of the type comprising a longitudinally extending portion and a body portion having a drive surface arranged to be engaged by a cooperating drive means of a driver.

The invention will be described primarily with reference to fastening devices comprising a longitudinally threaded portion and a body portion but it will be understood by the skilled man that the inventive concept can be applied to other rotating devices and some of these will be described.

Fastening devices of many kinds are already known and in particular, there are a number of existing fastening means of the type having a body portion and a longitudinally extending threaded portion in the form of a shank. Such fastening devices are commonly referred to as bolts and/or as screws. The threaded portion may be arranged to cooperate with a thread provided on another, threaded, element such as a cooperating nut or the threaded element may be provided on or in a body to which the fastening device is to be connected. Typically, the fastening device may be screwed into a first body in order to secure a second body to the first body or in order to secure the first body to a second body.

It has been found that known fastening devices are vulnerable to being removed by persons that it is desired should not be able to remove them, such that the first and second bodies may be separated. It is desirable to provide a fastening device which is not readily removed without use of a cooperating driver.

Existing fastening devices are have been provided with a number of drive surfaces such as simple slots provided in the body portion or head of the bolt or screw which may be engaged by a screwdriver in order to rotate the fastening device. Alternative drive surfaces that may be utilised are a variety of cross head slots which require a cross head screwdriver to engage in the cross head slot in order to rotate the fastening device. More recently drive surfaces in the form of hexagonal apertures and variations thereon have been provided in the head of the fastening device. A common problem with the simple slots and cross head slots is that the driver can slip within the slot reducing the amount of torque that can be applied and also leading to destruction of the drive means and/or fastening device if and when the driver slips out of, or within, the slot. This is known as to “cam out” or “camming out”. This problem is reduced by the use of a hexagonal aperture and a cooperating drive means. Similar problems can occur if the driver used is not an exact fit with the aperture.

According to a first aspect of the invention there is provided a rotating device arranged to rotate about an axis and having a body portion containing a cavity, the body portion having an upper surface having a substantially circular access hole therethrough generally of a first radius from the axis and providing access to the cavity, and at least one drive surface arranged to have force applied thereto to rotate the device and being provided in the cavity at least a second radius from the axis wherein the second radius is greater than the first.

The access hole may be of a circular cross section and an advantage of such an arrangement is that it is not possible to rotate the rotating device using the access hole which might otherwise negate advantages of the device.

The access hole may have at least one wall or face defining the access hole and the or each wall defining the access hole may be tapered toward or away from the axis. Indeed the or each wall defining the access hole may be curved. The or each wall may be provided with chamfered upper and/or lower edges. It is envisaged that the upper and/or lower edges may be sharply chamfered. The lower edge of the access hole may form a rim of the cavity in the body portion.

Conveniently, the cavity is partially defined by a side wall that is substantially parallel to the axis. Alternatively the side wall may be angled relative to the axis. Additionally the side wall may be planar or may be curved.

The cavity may have a lobed configuration and may be bi or tri lobed or may indeed be multi lobed. Alternatively the cavity may be oval.

The access hole may be centred upon the axis of the rotating device.

In one embodiment, at least a portion of the side wall of the cavity forms a drive surface. The drive face may be machined to normal machine matching standards. Non engaging portions of the cavity may be un-machined.

Alternatively the or each drive surface may extend from the side wall towards the access hole.

A first circumferentially extending face may further define the cavity. A second circumferentially extending face opposed to the first face and longitudinally displaced therefrom may also further define the cavity. The drive surface may be located between the first circumferentially extending face and the second circumferentially extending face.

The drive surface may extend radially and may be located between the first and second faces. The drive surface may comprise radial projections from the body portion into the cavity. The drive surface may be partially a circumferential face and/or may be partially located on a radial projection. The drive face may be planar or may be curved.

Conveniently, the first and second faces extend circumferentially around the body portion within the cavity and are longitudinally displaced and opposed such that a space between the two faces, that may be thought of as a groove or slot, is formed between and by the first and second faces. The drive surface may be located in the groove between the first and second faces.

Preferably the groove may be from 0.1 mm to 20 mm in width. More preferably the groove may be from 0.5 mm to 8 mm in width. Even more preferably the groove may be from 1 mm to 4 mm in width.

In one embodiment the drive surface extends substantially continuously around the body portion within the cavity.

Such a substantially continuous drive surface may have a discontinuous curvature. In some embodiments, the curvature may change in discrete steps around the circumference.

Generally the first and second faces are substantially perpendicular to the axis of the access hole. However, it is envisaged that it would possible for the first and second faces to be inclined relative to an axis of the access hole.

In a simple embodiment the drive surface may be hexagonal, square, or triangular in shape. Alternatively the drive surface may be lobed or curved. In some embodiments it is envisaged that the drive surface may be arranged to self locate a driver or provide a lead in to a driving position. Self location of the driver may be a particularly advantageous feature of the configuration of the drive surface. An oval or three lobed configuration has been found to be particularly advantageous.

Alternatively it is envisaged that a complex drive surface may be incorporated within a fastening device. Such complex drive surfaces may be serrated or possibly have a complex shape and this may be utilised as a security feature since it may then be necessary to have a corresponding drive means to engage with and rotate the rotating device. Such unique drive means may be provided for a specific project or application. Thus, a particular advantage of some embodiments of the present invention is that it can be used to provide a high security fastening device. In addition, the use of a drive means within an access hole and optionally additionally in a narrow slot or groove ensures that standard tools, such as a spanner, screwdriver or hexagonal driver should not engage with the drive surface within the groove or provide sufficient purchase against side walls of the access hole to rotate the device. Hence, use of a fastening device in accordance with at least one embodiment of the invention should prevent the removal of fastening devices without the use of forethought and preparation.

In a further modification of the concept of complex drive surfaces, it is envisaged that the rotating device may be formed with more than one drive surface located between the first and second circumferentially extending faces such that the more than one drive surfaces are longitudinally displaced from one another between the first and second faces. A driver arranged to co-operate with such a rotating device should be provided with drive means arranged to have co-operating drive means longitudinally displaced within the driver. Such an arrangement may provide additional security since the rotating device may only be engaged and rotated by a unique drive means.

A further advantage of at least some of the embodiments of the present invention is that the drive surface is located within the body portion and is not immediately visible. Indeed the configuration of the drive surface may not be apparent from an outside of the fastening device. In addition, the body portion or head of the rotating device such as a fastening device may be provided with an improved aesthetic.

The engagement between the drive means and the drive surface should be enhanced and the torque transmitted from the drive means to the rotating device should correspondingly be increased compared to existing fastening means. In some embodiments, the drive means is arranged to contact the drive surface around substantially the entire circumference of the drive surface. In other embodiments a number of drive surfaces are provided. It is believed that in some embodiments substantially more of the drive surface is engaged by the drive means than in conventional fastening devices.

The skilled man will understand that in practice only a proportion of a drive surface is actually contacted in use and driven off. In some embodiments this may be the same or less than the proportion of the drive surface engaged by drive means in conventional fastening devices.

Furthermore, it is believed that the engagement between the drive surface and the drive means is such that there is little or no rotation of the drive means relative to the body portion and thus there is little or no destruction of the drive means and/or drive surface in use. A particular advantage arising from this is that a rotating device in accordance with at least some aspects of the present invention may be formed of alternative materials such as plastics materials. It will be understood that moulded plastics may be provided with complex shaped drive means.

Additionally, a particular advantage is that once the driver has engaged with the drive surfaces of the rotating device, the rotating device can be securely and positively held and this can be of particular advantage where the rotating device is small, such as screws used in devices such as computers and also in miniaturised electrical equipment, and which are therefore not easily held by an operator before it is engaged with a co-operating body to which the device is to be fastened. It may also facilitate use of the rotating devices in automated manufacture since the rotating devices can be positively held by a robotic assembly device. This may be suited to fastening devices and also to rotating devices that require positive location and rotation to a desired orientation.

It may be desirable to arrange the configuration of the drive surface to positively locate or lead the driver into a driving location. Alternatively it may be desirable to provide a locating marker on the fastening device and driver to assist in correctly locating the driver relative to the fastening device. This may be advantageous where the drive surface is complex.

An additional advantage of the positive location between the driver and the rotating device is that it is not necessary to engage the driver with a driving face of the rotating device by means of pressure exerted through the driver and onto the rotating device. In conventional fastening devices such as a cross-head screwdriver engaging a cross-head screw, a substantially axial pressure is exerted in order to maintain contact between the screwdriver and the screw. If this pressure is not maintained, the screwdriver can slip within the cross-head driving face causing the drive to cease (“camming out”) and the drive face may be stripped or otherwise damaged to the point where it can be impossible to remove the screw using a screwdriver. Further, it can be counterintuitive to have to exert a pressure on a rotating device such as a screw in order to remove it from a body in which it is fixed. In contrast, in the present invention it is not necessary to apply a substantially axial pressure to engage the drive surface.

In an alternative embodiment, the cavity may extend longitudinally such that there is no second face defining the cavity; ie there is no lower extent of the cavity taking the first face adjacent the upper surface as the upper extent. The cavity may extend within a longitudinally extending portion of the rotating device such that the fastening device may be considered to be, at least partially, hollow. It will be understood that the skilled man may adjust the dimensions of the longitudinally extending portion, body portion, access hole and cavity in order to provide a rotating device having sufficient strength to withstand the forces generated in driving the rotating device without permanent deformation or damage.

It may be desirable to provide a fastening device comprising a body having a recessed or countersunk access hole.

The device may comprise a longitudinally extending portion providing a shank. Such a device may provide a screw, bolt, or other similar fastening device. The shank may have a hollow portion along the longitudinal axis for the whole or part of the longitudinal length of the shank.

Generally, the axis through the access hole may be the axis of the longitudinally extending portion, or at least parallel thereto.

The cavity may be formed as a truncated cone or be substantially conical in shape. The shape of the cavity may be dependent on the relative size of the body portion and the radius of the driving surface.

According to a second aspect of the invention there is provided a fastening device arranged to rotate about an axis and comprising a longitudinally extending portion and a body portion containing a cavity, the body portion having an upper surface having a substantially circular access hole therethrough generally of a first radius from the axis and providing access to the cavity, wherein the cavity is defined by at least a first circumferentially extending face, adjacent the upper surface, and a second circumferentially extending face longitudinally displaced from the first circumferentially extending face and at least one drive surface located between the first and second circumferentially extending faces.

According to a third aspect the invention there is provided a driver arranged to releasably engage with a drive surface on a rotating device in accordance with a first aspect of the invention or with the fastening device of the second aspect of the invention.

According to a fourth aspect of the invention there is provided a driver arranged to drive a rotating device according to either of the first or second aspects of the invention wherein the driver is arranged to have a plurality of separable elements moveable between a first position and a second position and having at least one driving flange arranged to co-operate with a corresponding drive surface of the rotating device in the second position and in which in use the rotating device is fixedly held by the driver in the second position.

According to a fifth aspect of the invention a driver arranged to drive a device according to the first or second aspects of the invention comprises a plurality of segments each having at least one driving face and arranged to moveably fit within the access hole in a first position, and a means of radially expanding the segments to displace the or each driving face to a second position in which the or each driving face is displaced to a location in the cavity.

Preferably the means of radially expanding the segments is biased to lock the segments in the second position. It is desirable that a force must be applied in order to move or allow the segments to move from the second position to the first position. Alternatively movement of the segments may be controlled by means such as a solenoid. Desirably a default location of the segments is in the second position. In the second position the segments are arranged to be able to engage the driving surface.

In another embodiment a torque limiting device may be fitted such that the segments are moved to the first position on reaching a predetermined torque. Another alternative is that the segments cannot move to the first position until a predetermined torque has been reached.

In a preferred embodiment a plunger is provided as means of expanding the segments from the first position to the second position. The plunger may be withdrawn allowing the segments to move to the first position. The plunger may have an extended location such that the segments are moved apart and displaced into the second position. Preferably the plunger is biased to the extended location. The plunger may be biased by means of a spring. Alternatively the plunger may be controlled by a solenoid.

In one preferred embodiment the driver substantially fills the cavity in the second position. Such an arrangement substantially reduces movement of the driver relative to the fastening device and so reduces the potential for slippage and damage of the driver and driving faces.

According to a sixth aspect of the invention there is provided a rotating device having a body portion, the body portion having an access hole with a first radius, the access hole terminating in a recessed cavity having a second radius greater than the first radius wherein at least one drive surface is located in the cavity, the or each drive surface extending from the second radius towards the first radius.

The skilled person will appreciate that a feature described in relation to any one of the above aspects of the invention may be applied, mutatis mutandis, to any of the other aspects of the invention.

The skilled man will appreciate that it is possible to provide an additional external coded drive located between longitudinally spaced surfaces. It may be desirable to provide such an external coded drive on a body portion of a rotating device in combination with an internal drive. A driver may be adapted to clamp over the body portion and locate on the external drive surface as well as locate with the internal drive surface. If the longitudinal spacing of the external drive surface is small the drive will still have the advantages of being tamper resistant.

The invention will now be described by way of example only with reference to the accompanying drawings in which:

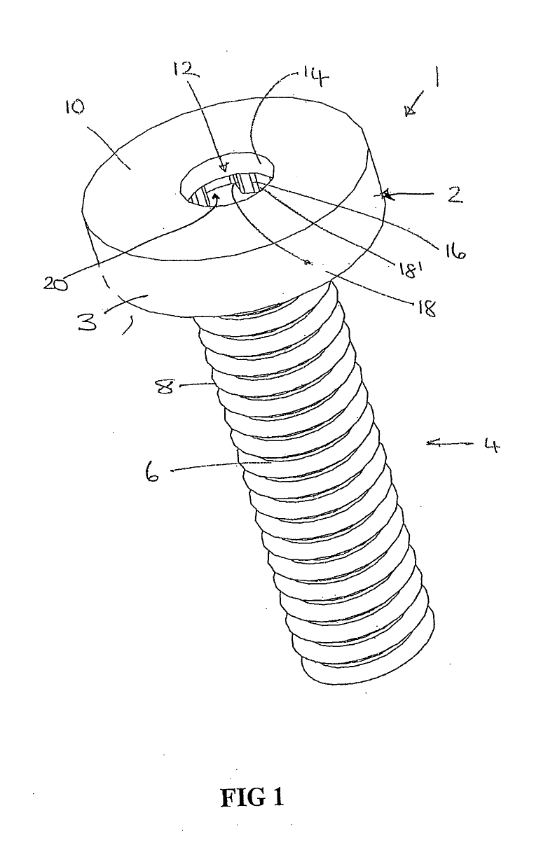

FIG. 1 is a perspective view of an embodiment of a rotating device in accordance with the invention;

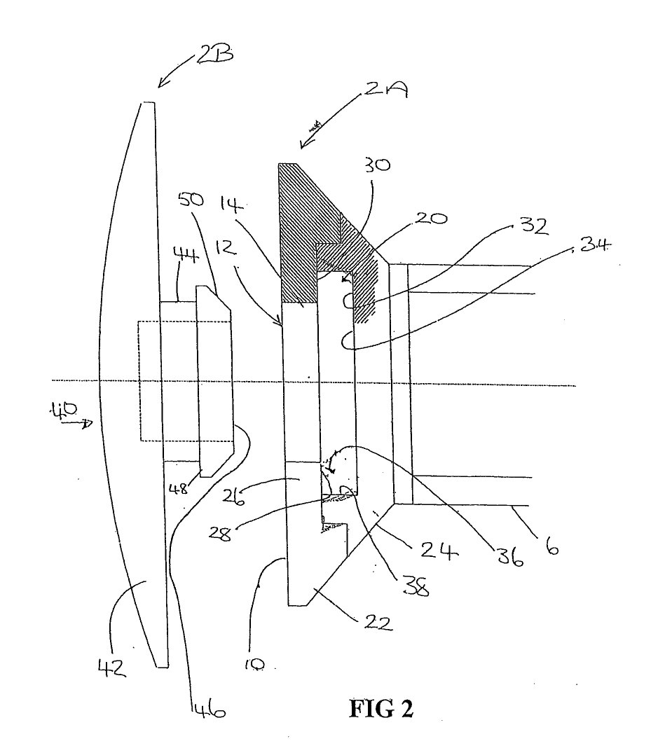

FIG. 2 is a cross section of an embodiment of a rotating device in accordance with the invention;

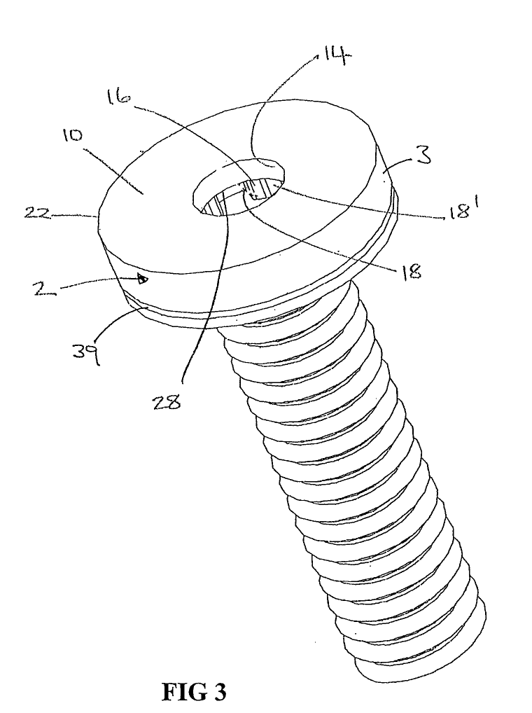

FIG. 3 is a perspective view of an alternative embodiment of a rotating device;

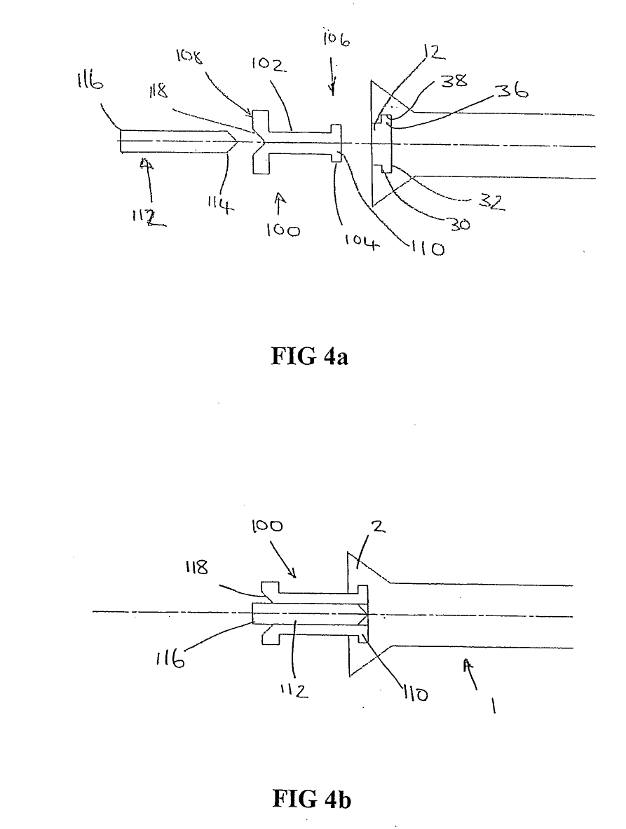

FIG. 4a is a cross section of a fastening device and a driver prior to engagement of a plunger with the driver;

FIG. 4b is a cross section of the fastening device, driver and plunger of FIG. 4b in a driving position;

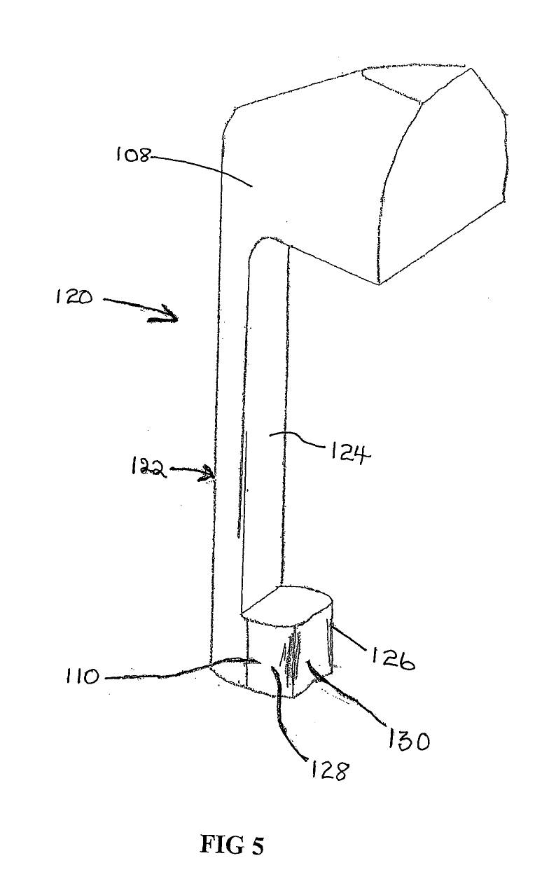

FIG. 5 is a perspective view of an embodiment of a segment of the driver shown in FIG. 4;

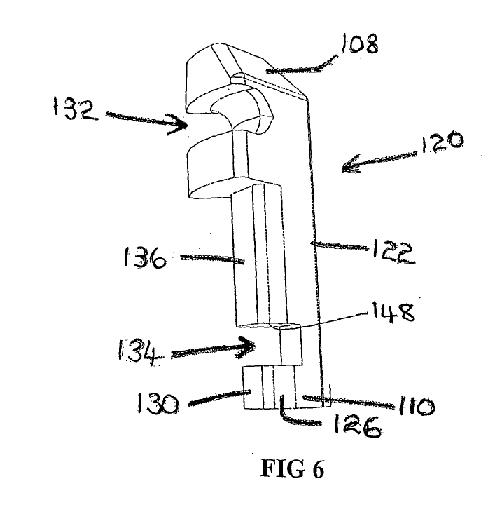

FIG. 6 is a perspective view of an alternative segment;

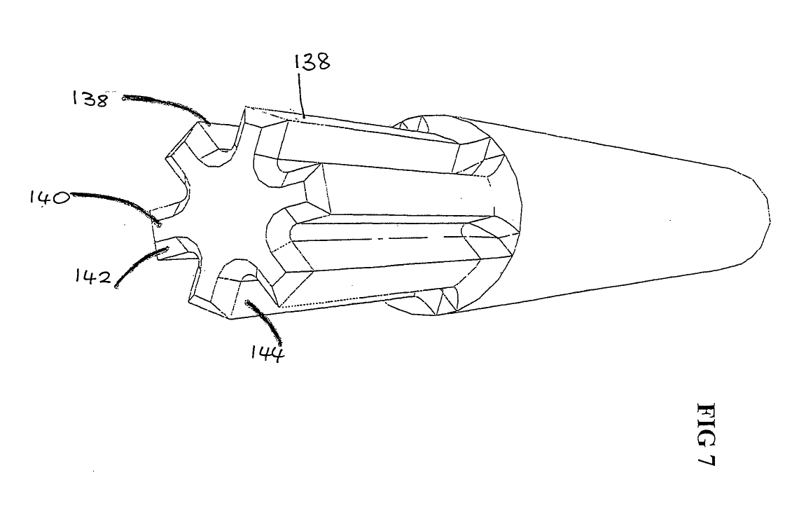

FIG. 7 is a perspective view of a plunger for use with the driver of FIG. 4;

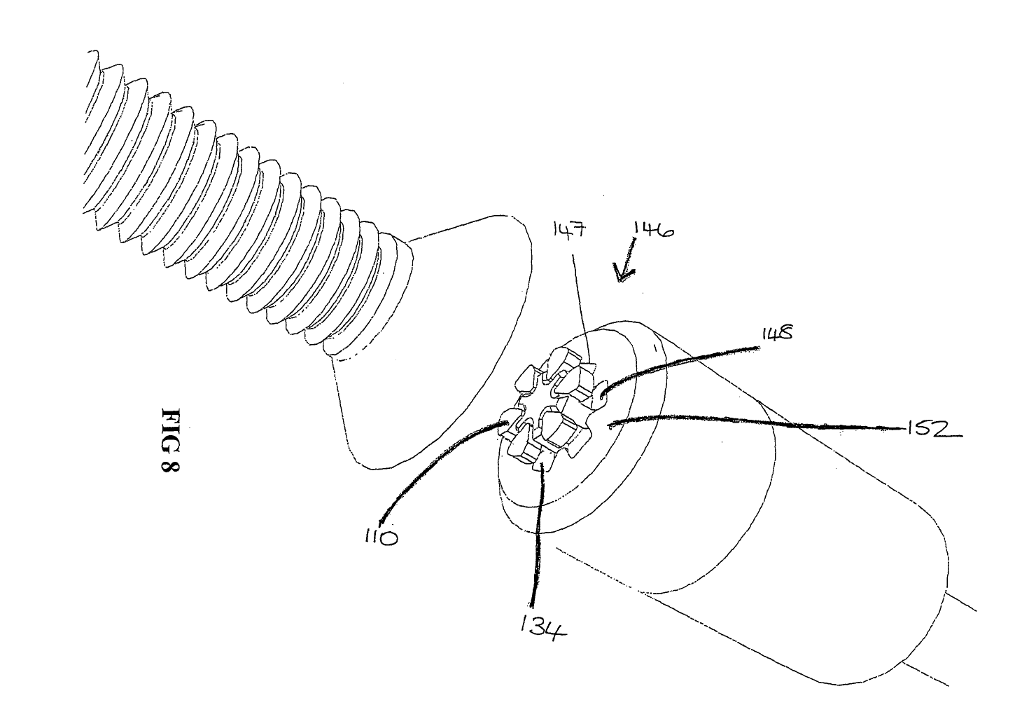

FIG. 8 is an illustration of a driver having segments as shown in FIG. 6 with the plunger in a driving position;

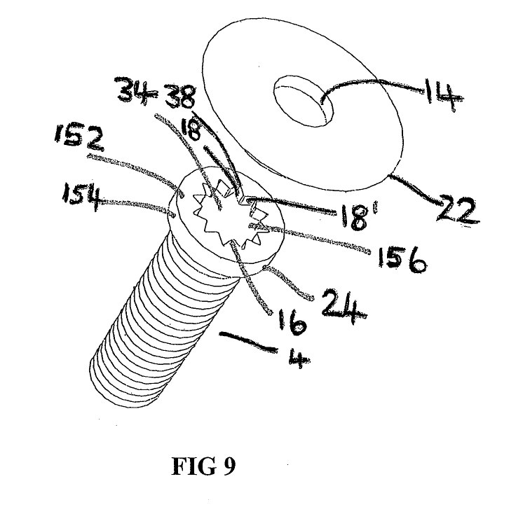

FIG. 9 is an exploded view of a rotating device having an alternative drive surface arrangement;

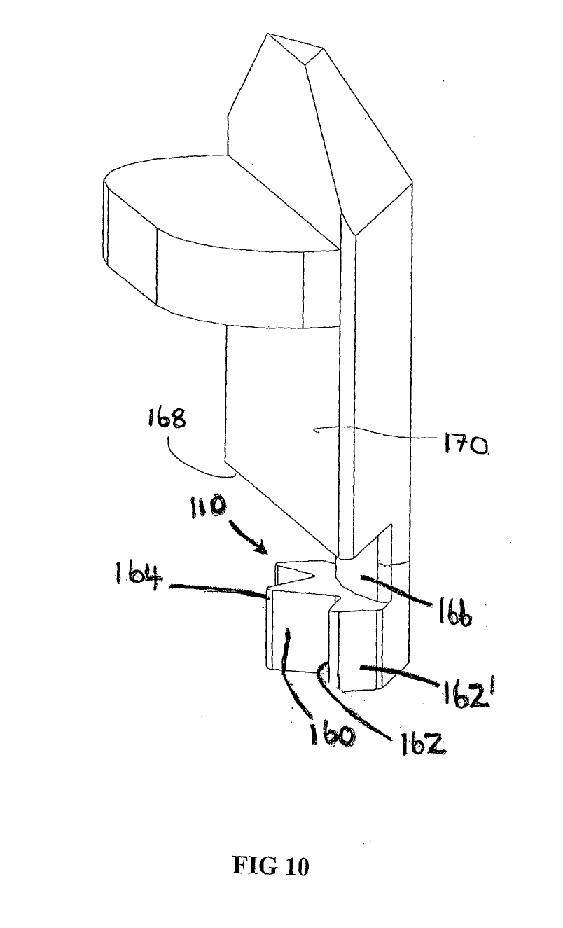

FIG. 10 is a view of a driver portion adapted to engage with the drive surface of FIG. 9;

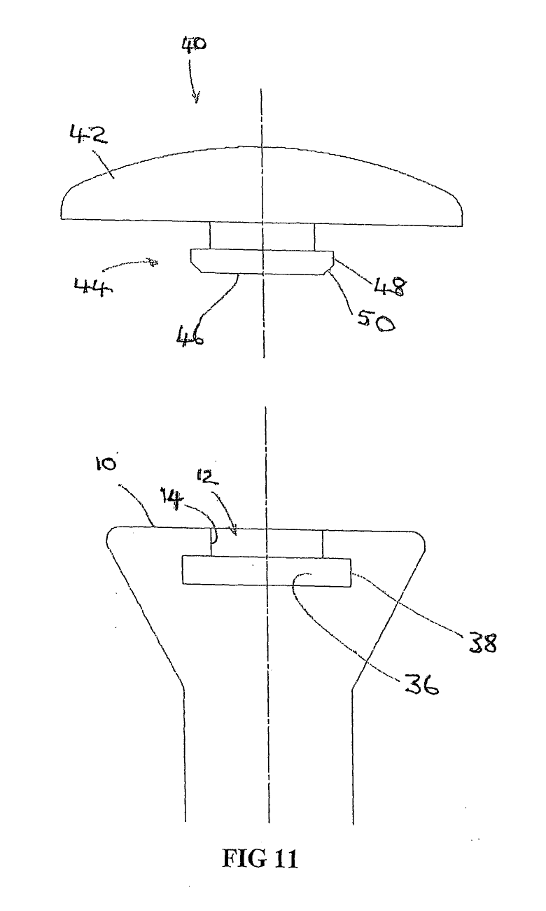

FIG. 11 is a simplified cross section of an alternative embodiment of the fastening device formed as a single piece;

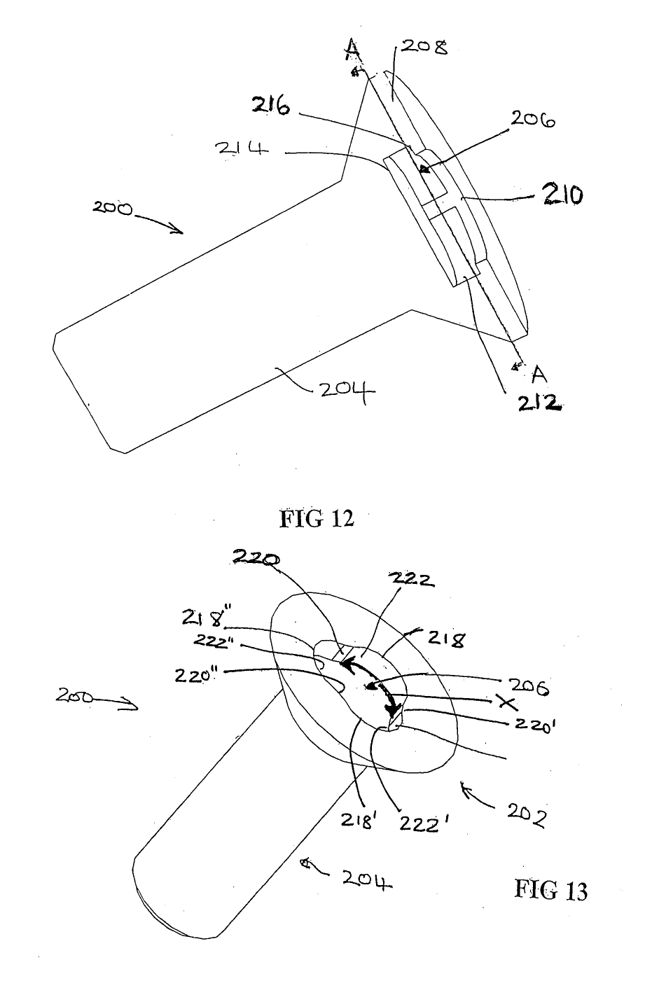

FIG. 12 is a cross section of an alternative embodiment;

FIG. 13 is a perspective view of a portion of the embodiment of FIG. 12, and

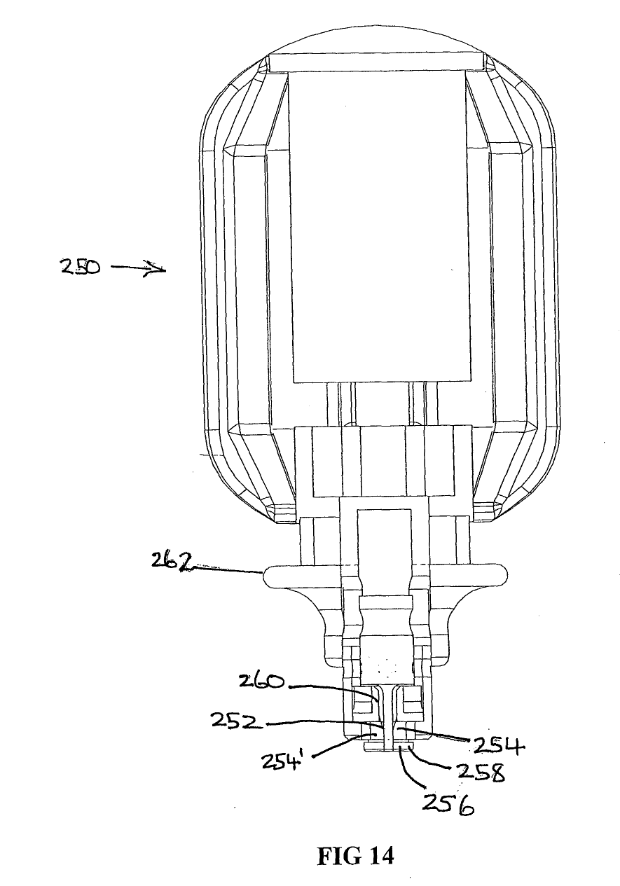

FIG. 14 is a cross section of an alternative driver.

The invention will be described with reference to a rotating device in the form of a fastening device but the skilled man will understand that the principles of the invention can be applied to many other rotating devices without deviating from the principles of the invention.

FIG. 1 shows perspective view of an embodiment of the invention in which a fastening device 1 comprises a body portion 2 having an external surface 3 and a longitudinally extending portion 4 in the form of a shank 6 provided with threads 8.

The body has a planar upper surface 10 in which there is an access hole 12 therethrough. The access hole is defined by a wall having an internal face 14 in the upper surface such that the access hole extends substantially longitudinally into a cavity 20 within the body portion 2. The device and the longitudinally extending portion share an axis that also extends longitudinally through the centre of the access hole. Projections 16 having at least a radial component, which may be termed, for convenience, radial projections are provided within a cavity 20 and extend towards the axis of the access hole and are coterminous with the internal face 14. Each radial projection 16 has two radially extending faces 18, 18′ which in this embodiment form drive surfaces with which a driver engages and to which torque is transmitted. Thus it will be seen that at least a portion of these faces (and therefore the drive surfaces) are further away from the axis than the internal face 14 which is at the first radius. Therefore, at least a portion of the drive surface is at a second radius from the axis which is greater than the first. It will be understood that is not essential that the or each radial projection is coterminous with the internal face 14 of the access hole.

FIG. 2 shows a cross-section through the fastening device. In this embodiment the body portion 2 is formed of two parts, a first body portion 2A and a cap portion 2B. The first body portion is a two-piece formation comprising an upper portion 22 and a lower portion 24. The upper and lower portions are connected together in manufacture and this will be described in more detail below.

A longitudinal access hole in the form of a bore 12 having a first radius extends through a centre of the upper portion 22 of the body and terminates in a cavity 20. The cavity is defined at its radial extent from the axis by a side wall at a second radius, greater than the first, from the axis.

Although the access hole is shown as being defined by parallel sides the sides may be tapered or vary in diameter along a length of the access hole. In addition, the access hole need not be perfectly circular although it is not desirable to deviate too far from circular as a non-circular access hole may provide a driveable surface in the access hole. The upper portion 22 comprises a rim 26 having a lip 28 extending around the access hole 12 and a first circumferentially extending face 30 of the upper portion 22 adjacent the upper surface. The rim may in some embodiments be angled to provide a chamfered portion of the access hole adjacent the cavity. Such a chamfered rim may facilitate insertion of a driving means. A second circumferentially extending face 32 is provided on the lower portion 24 and opposes the first circumferentially extending face 30 and is longitudinally displaced therefrom. In this embodiment the second face 32 forms a base 34 of the cavity 20 such that a groove 36 is formed between the first and second circumferentially extending faces. A further chamfer may be provided on the side walls of the access hole at junction between the access hole and the upper face 10. Such a chamfer may be for aesthetic reasons.

Alternatively, the base 34 of the access hole may be longitudinally displaced from the second and first faces 32, 30. The groove 36 is formed between the first and second faces and a side wall 38 extends therebetween. The side wall 38 is therefore offset and substantially parallel to the access hole 12 (and also in this embodiment is offset from and substantially parallel to the threaded shank 6). The side wall is radially off-set from the longitudinally extending axis of the access hole and is substantially parallel thereto. The side wall 38 may be provided with a roughened or knurled surface by shot blasting or other conventional methods and may act as a drive surface in some embodiments.

A perspective view of an alternative fastening device can be seen in FIG. 3. The upper portion 22 of the body has a planar upper surface 10 through which the access hole 12 extends. An internal face 14 of the access hole extends substantially longitudinally into the body portion 2 adjoining the lip 28. Projections 16 having at least a radial component, which may be termed, for convenience, radial projections extend from the side wall towards the centre of the access hole and are coterminous with the internal face 14. Each radial projection 16 has two radially extending faces 18, 18′. It will be realised that in an alternative embodiment the driver may also engage with the side wall 38 and torque may also be transmitted to the fastening device thereby. It is not essential that the radial projections are coterminous with the internal face 14 of the access hole. The projections may simply extend from the side wall 38 towards the access hole. In some embodiments, the projections 16 may extend beyond the internal face 14 of the access hole 12. A continuous circumferential narrow channel 39 is formed in the external surface 3 of the body 2 in the embodiment shown in FIG. 3. The channel 39 may be used to provide additional stability for a driver adapted to rotate the device and/or to apply additional torque transmission to the rotating device. The channel may have an internal drive face and a shape of the internal drive face of the channel 39 may be varied and may be square, triangular, hexagonal or may be of a coded shape, or any other suitable shape which allows a drive means to engage therewith to provide stability to the driver and/or to transmit torque to the rotating device. It will be understood that is not essential that the channel 39 is continuous nor that the channel 39 is essentially in a plane parallel with the upper surface 10.

It will be realised that the internal drive has advantages in that the drive is efficient and improves torque transmission from the driver to the rotating device. Further, the cam out potential of the drive means of the driver slipping relative to the drive surface is reduced relative to conventional drive means and driver systems and so the drive surfaces are less likely to be damaged in use.

Whilst some cross-head systems claim to “cam out” less than others, a significant advantage of the drive system as disclosed herein is that it cannot easily “cam out” due to its nature of being locked in place.

The fastening device of FIG. 2 has a cap portion 2B having a cap 40 which has a domed portion 42 and a projection 44 dimensioned to fit within the access hole 12. A distal end 46 of the projection 44 is provided with a lip 48 having a chamfered leading edge 50 arranged to facilitate insertion of the projection 44 within the access hole 12 and location of the cap 40 on the first body portion 2A. The cap 40 can be fitted to the fastening device once it has been positioned and fastened to a body. The cap 40 provides a pleasing aesthetic and additionally prevents unauthorised access to the drive surface of the fastening device.

In some embodiments, the cap 40 may be arranged such that once inserted into the cavity 20 it cannot be readily removed. The cap may be arranged such that removal from the fastening device results in damage to the cap 40, generally such that the cap cannot be re-used.

A cross section of a drive means 100 ready for insertion into the fastening device 1 can be seen in FIG. 4a. The drive means 100 comprises a central portion 102 having driving flanges 104 at a first end 106 and a head portion 108 at a second end remote from the first end. The driving flanges 104 are sized to pass through the access hole 12. Each driving flange 104 has an extension or projection 110 adapted to fit within the groove between the first 30 and second 32 circumferentially extending faces.

As can be seen in FIG. 4a the driver has a first arrangement in which it is able to be inserted or removed from the access hole 12 and in this arrangement the extensions 110 do not extend into the groove 36 between the first and second circumferentially extending faces and are not able to engage with the side wall 38 or radially extending faces of the radial projections.

A plunger 112 is provided which is arranged to adjust the drive means from the first arrangement to a second driving arrangement in which the extensions 110 extend between the first and second circumferentially extending faces. The plunger has a head end 114 and a tail end 116. The head end 114 is chamfered such that it can be located in the head portion 108 of the driving means. FIG. 4b shows the plunger inserted into the drive means and the drive means in a driving position in the fastening means.

In one embodiment the driving means is divided into six segments 120, one of which is shown in FIG. 5.

Each segment comprises an intermediate portion 122, a radially extending flange or projection 110 and a radially extending head portion 108. The head portion extends upwardly and radially from the recess 118 formed where all of the segments meet. The central portion of each segment is angled toward the centre and has a curved outer surface 124 adapted to fit within the access hole 12 and sized to be able to rotate without restriction therein. The intermediate portions of each segment abut to form the central portion 102 of the drive means 100. Each projection 110 has first and second radial faces 126, 128 and a circumferentially extending tangential face 130. It is envisaged that the radial faces may engage with the radial faces on the radial projection of 16 of the body portion 2 in order to drive rotation of the body portion and thus of the fastening device. Alternatively the tangential face 130 of the flange may engage with a roughened or knurled surface of the side wall 38 in order to rotate the body portion.

An alternative from of a segment is shown in FIG. 6. The segment comprises a head portion 108 and an intermediate portion 122 and a radially extending projection or flange 110. The upper head portion has the same general form as in the embodiment of FIG. 5 but a recess 132 has been provided in order to locate an element such as a spring, split ring, o-ring or other such means that returns the segments to a closed position, Alternative suitable retraction means may be provided and the recess may be alternatively formed in order to locate the retraction means. It can be seen that the intermediate portion 122 has a slot 134 and a rib 136. As before, the flange 110 is arranged to be outwardly displaced and to move into the groove or cavity in the body portion of the fastening device in the driving position. The tangential face 130 may contact and drive a surface on the side wall of the cavity or the radial faces 126, 128 (not shown in FIG. 6) may move into engagement with drive faces on radial projections provided in the cavity. The segments are sized to be able to move freely through the access hole in the closed, non driving position. In this embodiment the slot 134 is dimensioned to fit over the inwardly projecting rim 26 of the access hole (i.e. to accommodate the upper surface of the device). The rib 136 extends outwardly and is substantially of the same cross section as the projection 110. The rib may provide additional strength to the segment.

The plunger 112 in FIG. 4a is shown in more detail in FIG. 7 and comprises a number of spokes 138, in this case six, which are arranged to fit between and act on the segments 120 of the driving means. Each spoke 138 has a head end 140 having chamfered edges 142 arranged to enter between the segments of the driving means and move the segments radially outwards within the access hole such that the flanges 110 are moved into engagement with or adjacent to the side wall 38. Each spoke 138 has substantially parallel sides 144 that abut and displace segments of the driving means. If the driving means is to rotate the body portion by engaging with the side wall 38 the tangential face 130 of the segment is moved into contact with the side wall 38. If the radial faces 126, 128 are to engage and drive radial drive surfaces on the projection 16 the side wall 38 may not be engaged when the plunger has been inserted since it may be preferable to facilitate free rotation of the driving means.

In use the driver is inserted into the access hole and then the plunger 112 is placed in the recess 118 of the drive means and inserted such that the plunger 112 slides between and separates the segments, radially displacing the flanges to a location in the groove between the first and second circumferentially extending faces as can be seen most clearly in FIG. 4b. The plunger transmits torque to the segments and thereby to the drive surfaces. It can be seen in FIG. 8 that the six segments may be provided in a head 146 of a driver. The segments are located in a mating opening 147 provided in the head 146 of the driver having a complementary shape to the segments. The rib 136 of each segment may engage with the mating opening 147. However, the opening need not be of complementary shape to the segments. The mating opening 147 is sized to allow the segments to move outwardly to the driving position. In use, the plunger 112 is withdrawn from the head 146 allowing the segments to be retracted to the first arrangement such that the segments of the driver can be inserted into the head of the rotating device. Once the segments have been inserted and the flanges 110 are located such that they are able to move outwardly into the cavity at a terminus of the access hole, the plunger is moved displacing the segments to the driving position. The slot 134 assists in locating the segments in the correct position. Once the segments are correctly located and locked into the driving position, the driver can be rotated. This may be by rotating the head 146 or a handle may be joined to the head to facilitate rotation of the driver.

As can be seen in FIG. 8 a first face 148 of the slot 134 of a segment 122 is aligned with a face 152 of the head 146. The first face 148 of the slot 134 is most clearly seen in FIG. 6. In use the slot would then be aligned with the rim 26 of the body 2 and the segments 120 would be positioned such that the projections 110 can be outwardly moved into the cavity.

In an alternative arrangement a location marking may be provided on the upper face 10 of the body which can be matched to a location mark on the driver. Alternatively a locating feature may be formed in the base 34 of the access hole. The locating feature such as a slot or groove may be formed to receive and cooperate with an end of the plunger 112. Such a locating feature may be more desirable where tamperproof features are less important.

It is envisaged that the drive surface formed by the side wall 38 and the radially extending faces 126, 128, and tangential face 130 of the extension or projection 110 can be coded by means of providing a specific shape and the driving means is also coded in order to engage with the coded drive surface. The location and form of the projections may be altered to provide a unique key. Additionally, or alternatively, the groove or cavity may comprise a number of “drive surfaces” longitudinally displaced from one another and the driving means is coded to interact with each of the drive surfaces in order to rotate the body portion. The drive means may be inserted in the same way as before but in this case may require location to engage with the drive surfaces.

It will be understood that the shape of the drive surface on the side wall may be varied and may be square, triangular, hexagonal or may be of a coded shape, or any other suitable shape which allows a drive means to engage therewith and transmit torque to the fastening device. Additionally a longitudinal length of the drive surface may be varied in order to increase security.

An alternative drive surface is shown in FIG. 9 and a segment adapted to engage with and drive the drive surface of FIG. 9 is shown in FIG. 10. Corresponding reference numerals have been used for corresponding features. FIG. 9 is an exploded view of a fastening device having a shank 4, a body portion 2 comprising an upper body portion 22 and a lower body portion 24. As can be seen the lower body portion 24 comprises a ring 152 having an outer face 154 to which an inner face of the upper portion 22 is secured in manufacture of the fastening device. A recess 156 is stamped in the lower body portion 24 and this recess forms the cavity at the terminus of the access hole 12 in the upper body portion. A face 34 extends across a base of the recess and forms a second circumferential face in the fastening device. The recess is formed with a side wall 38 and a series of projections 16, each projection having radially extending faces 18, 18′ which form drive surfaces. Once the upper body portion is fixed to the lower body portion the rim and lip extend over the projections 16. An inner face of the projections can be arranged to be coterminous with the inner face 14 of the access hole of the body portion but can also be recessed below the rim. A lower face of the body portion can form the first circumferential face 30 in the cavity 20.

A segment adapted to drive the fastening device of FIG. 9 is shown in FIG. 10. The segment is generally similar to that of FIGS. 5 and 6. It can be seem that the projection 110 has a series of angled teeth 160 that are arranged to cooperate with the projections 16 on the fastening device. Each tooth 160 has driving faces 162,162′ and an end face 164 that may or may not engage with the side wall 38. As before a slot 166 facilitates location of the segments in the cavity. A first face 168 also facilitates positive location of the segments prior to moving the segments to the driving position. In this embodiment a rib 170 does not have the same general cross section as the projection 110.

In some embodiments, the groove or cavity may be narrow and it is envisaged that the groove width may be between roughly 0.3 mm and roughly 3 mm between the first 30 and second 32 circumferentially extending faces. The groove may be narrower or wider depending on the material from which the fastening device is formed and the desired function of the fastening device. It is envisaged that the groove may be wider than the widths outlined above in embodiments where two or more longitudinally displaced drive surfaces are located between the first and second circumferentially extending faces since each drive surface has a discrete width. Advantages resulting from the use of several coded drive surfaces may be considered to overcome any disadvantage arising from widening of the groove.

An alternative embodiment of a fastening device and cap is shown in FIG. 11. In this embodiment the fastening device is a single piece formation rather than being a two piece formation having upper and lower body portions. In the embodiment described and illustrated in FIG. 11, the cap 2B is domed and may have an aesthetically pleasing shape. Fastening devices having domed upper surfaces are typically referred to as pan-headed and are commonly used in fitting furniture such as mirrors in hotels and other public places. It has been a problem that guests have removed known pan headed screws and have removed or damaged mirrors and other room furniture in such public spaces. It is envisaged that as fastening devices in accordance with embodiments of the invention requires a special co-operating drive means it is unlikely that guests or other users of public spaces would be carrying anything that can engage the drive surface provided in the body portion of the fastening device and rotate the fastening device to remove a body fastened thereby.

FIG. 12 is a cross section of an alternative fastening device 200. The device comprises a body portion 202 and a shank 204. The body portion has a cavity 206 formed therein. An upper portion 208 of the fastening device is provided with a circular access hole 210 in the upper portion extending therethrough and into the cavity 206. A groove 212 is formed between the base 214 and a lip 216 of the upper portion 208 of the fastening device.

FIG. 13 shows a section of the fastening device 200 along the line A-A in FIG. 12. In this embodiment the cavity 206 has three lobes 218, 218′, 218″ and three radial projections 220, 220′ 220″. A drive surface 222, 222′ 222″ is formed in the curvature of the respective lobe 218, 218′, 218″ extending to the respective projection 220, 220′ 220″ and the total potential drive surface may be less than 100% of the circumferential distance of the cavity, that is a peripheral distance around the lobes and projections. The potential drive surface 222, 222′, 222″ may be a whole of a periphery of each of the lobes as indicated by the line referenced X. In practice the actual drive surface on which a driver contacts the potential drive surface of the fastening device may be a portion of the potential drive surface and may be significantly less than the potential drive surface.

In other embodiments the cavity may be oval or bi lobed or may be multi-lobed. It has been found that a cavity which is oval, bi, tri or multi-lobed may be advantageous in self-locating a driver for use with the fastening device.

FIG. 14 is a cross section of a driver suitable for use with a fastening device as shown in FIGS. 12 and 13. The driver comprises a handle 250 and a plunger 252. The plunger 252 acts on a pair of segments 254, 254′. Each segment 254, 254′ comprises a driving flange 256 having a projection 258 adapted to fit in the groove 220. Each segment is recessed at 260. A spring is provided to act on the plunger and bias the plunger to an extended position as shown in FIG. 14. The segments are biased toward the plunger. A lever 262 acts on the plunger and enables it to be retracted to an insertion position. In the insertion position the plunger is between the recesses 260 and the bias of the segments towards the plunger moves the segments inwards allowing the projections to be withdrawn from the groove and the driver to be disengaged from the fastening device. Release of the lever 262 allows the plunger to extend and displace the segments to the driving position once more. Thus it will be understood that the default arrangement of the driver is with the segments in the driving position. Once the driver is connected to a fastening device a user must make a positive decision to release the driver from the fastening device by moving the lever 262. In the default arrangement the fastening device is securely and positively attached to the driver.

A particular advantage is that once the rotation device has been pre-located on the driver the segments are biased to the driving position and the driver cannot be separated from the rotation device without a definite intention of a user. Accordingly the driver and rotation device can be used in situations such as in dark locations or underwater where it would be undesirable to drop the rotation device.

It has been found that a fastening device in accordance with the invention has a narrow drive surface. Accordingly, a low profile head, as illustrated in FIGS. 1 and 11, may be used for the fastening device. Since only a narrow portion of the body is required for the drive mechanism use of a rotating device in accordance with an aspect of the invention allows a freedom of cosmetic design. A low profile head may be advantageous in terms of weight and wind/fluid flow. Alternatively, the body portion may be formed into a post or column. A cosmetic cover or cap may be attached to the fastening device by means of flanges engaging in the recess in the body portion. Ancillary elements may additionally be attached to the fastening/rotating device by means of the engagement with the access hole or cavity.

A particular advantage of the use of a driver and rotating device as described with reference to fastening devices is that the rotating device is positively held by the driver prior to being rotated and engaged with a body or after the fastening device has been removed from a body to which it has been fastened. Thus, the fastening device may be pre-located in the driving means and held therein in a fixed orientation; ie the fastening may be held in a substantially secure orientation relative to the driver. This may facilitate the location of fastening devices such as screws and/or bolts. This may be particularly useful where the bolts and/or screws are small and may be difficult to locate in the respective aperture. Thus, fastening devices or rotating devices in accordance with the invention may be of particular interest to the computer and electrical industry involved in the construction of equipment having a number of small or difficult to locate fastenings or devices. This may be particularly relevant to the use of screws in miniaturised equipment. This aspect may also be of a particular advantage in the use of robotic equipment for assembly of articles since the fastening or device is securely and positively located in the driving means. A further advantage that is applicable to rotating devices in general is that pre-location of the body portion in the driving means facilitates location of the rotating device to a pre-determined orientation.

Some embodiments may be arranged such that the plunger 112 cannot be retracted from the extended position between the segments 120 of the drive means 100 until a pre-set torque has been applied to the drive means 100. An advantage of such an arrangement is that is can help to ensure that a fastening device has been tightened to that torque. In such embodiments, a cap 40 may be applied bearing a legend or other indicia indicating that the correct torque has been applied to the fastening device. It may be convenient to arrange such a cap 40 such that removal from the fastening device destroys the cap.

Alternatively the plunger may be arranged such that it is retracted from the extended position when a pre-set torque has been achieved so avoiding over torqueing of a fastening or rotating device.

It is further envisaged that the drive means may be provided on a suitable handle arranged to be easily held and rotated by an operator. The handle may be varied. The handle may be attached to a robot. The rotating device is pre-located and the orientation may be predetermined. The drive means is not released from the rotating device until it is ascertained that the rotating device is correctly and securely located.

It has been found that the torque that can be applied to the fastening device is at least in line with the torque that can be applied to conventional fastening devices and may be greater in some instances.

A calculation of the torque transmitted and its relation to torques transmitted for conventional thread sizes is set out in Table 1

TABLE 1
Calculation of the torque transmitted for a range of drive hole
diameters

| Drive Hole | Torque | Typical |
|---|---|---|
| Diameter | Transmitted | Thread |
| (mm) | (Nm) | Size |
| 3 | 4 | M4 |
| 3.5 | 6 | M4 |
| 4 | 9 | M5 |
| 4.5 | 13 | M6 |
| 5 | 18 | M6 |
| 5.5 | 24 | M6 |
| 6 | 32 | M8 |
| 7 | 50 | M8 |
| 8 | 75 | M10 |
| 9 | 107 | M10 |
| 10 | 146 | M12 |
| 12 | 253 | M14 |
| 14 | 402 | M16 |
| 16 | 600 | M20 |
| 18 | 854 | M22 |
| 20 | 1,172 | M24 |
| 22 | 1,560 | M27 |
| 24 | 2,025 | M30 |

Tests have been carried out in respect of an 8 mm drive hole diameter which provided the actual transmitted torque value for normalising the calculated transmitted torque for the range of drive hole diameters shown in Table 1. The fastener was not tested to destruction and so it is envisaged that higher torques may be achieved. Additionally the fastener and relevant parts of the driver were formed of hardened EN16 and harder materials may be used.

As referred to above, in one embodiment the upper and lower portions 22, 24 are connected together in the course of manufacture. As is carried out in conventional methods the lower portion may be cold stamped. The upper portion 22 may be joined to the lower portion by means of preferential heat shrinking in which the upper portion is heated and dropped or placed onto the lower portion. Contacts or other locating features may be provided to locate the upper portion 22 correctly with respect to the lower portion 24. As the upper portion cools, it shrinks and forms a tight fit with the lower portion. It is envisaged that the contact faces between the upper and lower faces may be angled to provide a stronger bond between the upper and lower portions. Alternatively, the upper and lower portions may be joined by friction welding, hot or cold stamping or adhesive bonding. Suitable materials comprise carbon steel, stainless steel, aluminium alloys, brass or a combination of these materials in a two-part formation of the fastening device.

It is envisaged that if the upper and lower portions are both of metal the upper portion may be shrunk onto the lower portion. If the upper portion is formed of plastic it may be overmoulded onto the lower portion. The use of a plastic upper portion may be advantageous in that facilitates the use of colour coding of fastening devices or improved aesthetics. This may be particularly advantageous for architectural fastenings which may use colour as a feature. Such fastenings may be used in roofs and cladding, either internal or external. It may also be possible to apply an upper portion comprising a logo or other individualisation. Alternatively the upper portion may be preformed and fitted to the lower portion by forcing over the lower portion and shrink fitting it thereto.

Either the upper portion or the lower portion, or both, may be manufactured from more than one part. In one method a washer or other insert having a substantially circular central aperture may be placed over the lower portion. The insert may be arranged such that an underlip is formed as the first circumferentially extending face. A polymer cap may then be overmoulded onto the fastening device. An advantage is that a mould for injection moulding the overmoulding may be simpler if a washer or other flat formed insert is provided. It has been noted that in forming an overmoulding for the upper portion of the fastening device it is difficult to form the mould such that plastic material does not enter the drive cavity. It has been found that a washer, or other insert, may be used to provide a substantially circular central aperture that will form the access hole in the final fastener. The central aperture may be blocked during overmoulding of the upper portion so preventing ingress of the plastics moulding material into the cavity. The washer or other insert may be formed of metal or other materials that are suitable for use in an injection moulding method. Typically an injection moulding method may be at a temperature of about 180° C.

In an alternative embodiment the fastening device may be formed with unitary upper and lower portions and may be manufactured by forging or cold forming. The body portion may be formed and a hole pierced therein creating an upstand around a perimeter of the hole. The body portion can then be cold formed to roll over the upstand and form an “upset” or inwardly extending lip around the perimeter or rim of the hole. Such methods are well known in the art and will not be further described.

As has been discussed above the fastening or rotating devices may be formed of a plastics material. Suitable polymers can be selected from “engineering plastics” such as NYLON, POLYETHYLENE, ABS or PEEK. PEEK may be more suitable for high stress applications. Alternatively glass filled nylon may be used. It may also be desirable to use nano-polymers for high stress applications. Polymer devices having an internal drive may be formed in a single part or in a two-part fastening. In the two-part method a lower part of the fastening is moulded comprising a fastening means or operating mechanism and has the drive feature moulded onto a top surface and a location feature moulded into an upper surface. An upper part can comprise a disc incorporating features arranged to fit over lower part and an aperture defining the access hole through which the driver can access the drive surfaces. The two parts may be manufactured using injection moulding processes and may be joined by means of a variety of welding processes such as ultrasonic, friction or heat or by means of adhesive bonding.

In a single part approach the manufacturing process may be by means of injection moulding incorporating lost-metal or lost wax techniques to form the cavity. There is no longer a need to join two parts of the device but there can be additional costs arising from a need to manufacture, insert and subsequently remove the lost metal core. Accordingly, the two-part approach is preferred. An alternative manufacturing process may be to micromachine the head of the fastening device.

It is also envisaged that the fastening device may be formed from a ceramic material. Appropriate manufacturing techniques will be clear to the skilled man.

It is envisaged that the drive means may be applied to devices or objects other than fastening devices in which case the drive means may be incorporated into other rotating mechanical devices including such devices as latches and cam locks. It will be appreciated that the positive location and precise control afforded by a drive surface as described may be advantageous in many situations. It is envisaged that the positive location of the rotating device in the drive means would be of particular advantage in miniature applications such as watches and fine instruments. Additionally it could be useful in automated assembly of components by means of remote control.

Rotating and/or fastening devices with an internal drive may be of particular use in situations where the head or body portion of the device is located on or below the surface of the body to which the device is attached. Fastening devices in accordance with an aspect of the invention may be used as an alternative to traditional countersunk fastening devices.

Uses for fastening and rotating devices in accordance with the invention are envisaged in the automotive industry where the positive location and suitability for automated assembly are advantageous. The fastening devices may also be used in fixing panels in industries such as marine, transport, aerospace, furniture assembly and white goods manufacture.

In addition it will be understood that a rotating device as described may be incorporated in instrumentation such as potentiometer trimming devices and also in providing an adjustment means for a setting point of a temperature controller or humidity controller etc. It will be understood that a rotatable device in accordance with the invention would provide a more secure adjustment of a setting point than can be achieved with traditional buttons or screwdriver slot adjusters.

1. A rotating device arranged to rotate about an axis and having a body portion containing a cavity, the body portion having an upper surface having a substantially circular access hole therethrough generally of a first radius from the axis and providing access to the cavity, and at least one drive surface arranged to have force applied thereto to rotate the device and being provided in the cavity at least a second radius from the axis wherein the second radius is greater than the first.

2. A rotating device according to claim 1 in which the cavity is oval or is one of bi, tri or multilobed.

3. A rotating device according to claim 1 or claim 2 wherein the body portion has at least one of the at least one drive surfaces arranged to have a force applied thereto, the drive surface being located between a first circumferentially extending face and a second circumferentially extending face opposed to the first face and longitudinally displaced therefrom.

4. A rotating device according to claim 1 to 3 wherein the first and second faces are substantially perpendicular to the axis.

5. A rotating device according to any preceding claim wherein the drive surface extends around at least a portion of a side wall of the cavity in the body portion.

6. A rotating device according to claim 4 wherein the drive surface extends substantially continuously around the side wall of the cavity in the body portion.

7. A rotating device according to any of claims 1 to 3 wherein two or more discrete drive surfaces are located in the cavity in the body portion.

8. A rotating device according to claim 3 wherein the body portion is provided with two or more discrete drive surfaces longitudinally displaced from one another.

9. A rotating device according to claim 7 wherein the body portion is provided with one or more projections having at least a radial component, the or each projection having at least one radially extending drive face.

10. A rotating device according to any preceding claim wherein the body portion comprises an upper portion and a lower portion.

11. A rotating device according to claim 10 wherein one or both of the upper and lower portions are manufactured from more than one part.

12. A rotating device according to claim 10 or claim 11 wherein the upper portion is manufactured from a plastics material.

13. A rotating device according to claim 11 wherein the upper portion comprises an insert having a substantially circular central aperture and an overmoulding, preferably a plastics overmoulding.

14. A driver arranged to releasably engage with a drive surface on a rotating device in accordance with any of claims 1 to 13.

15. A driver arranged to drive a rotating device according to any one of claim 1 to claim 13 wherein the driver comprises a plurality of separable elements moveable between a first position and a second position, wherein each element has a projection arranged to cooperate with a corresponding drive surface of the rotating device in the second position and wherein the rotating device is fixedly held by the driver means in the second position.

16. A driver arranged to drive a fastener according to any one of claims 1 to 8 wherein the driver comprises a plurality of segments each having at least one driving face and arranged to moveably fit within the access hole in a first position, the driver further comprising a means of radially expanding the segments to a second position in which the or each driving face is displaced to a location in the cavity.

17. A fastening device arranged to rotate about an axis and comprising a longitudinally extending portion and a body portion containing a cavity, the body portion having an upper surface having a substantially circular access hole therethrough generally of a first radius from the axis and providing access to the cavity, wherein the cavity is defined by at least a first circumferentially extending face, adjacent the upper surface, and a second circumferentially extending face longitudinally displaced from the first circumferentially extending face and at least one drive surface located between the first and second circumferentially extending faces.

18. A driver arranged to releasably engage with a drive surface on a fastening device in accordance with claim 17.

19. A driver arranged to drive a rotating device according to claim 1 or claim 17 wherein the driver is arranged to have a plurality of separable elements moveable between a first position and a second position and having at least one driving flange arranged to cooperate with the a corresponding drive surface of the rotating device in the second position and in which in use the rotating device is fixedly held by the driver in the second position.

20. A driver arranged to drive a fastener in accordance with claim 1 or claim 17 wherein the driver comprises a plurality of segments each having at least one driving face and arranged to moveably fit within the access hole in a first position, and a means of radially expanding the segments to displace the or each driving face to a second position in which the or each driving face is displaced to a location in the cavity.

21. A rotating device having a body portion, the body portion having an access hole with a first radius, the access hole terminating in a recessed cavity having a second radius greater than the first radius wherein at least one drive surface is located in the cavity, the or each drive surface extending from the second radius towards the first radius.
